(19) United States
(12) Patent Application Publication
(10) Pub. No.: US 2026/0089143 A1
(43) Pub. Date: Mar. 26, 2026

(54) KEY REFRESH FOR A CONNECTION

(71) Applicant: Intel Corporation, Santa Clara, CA (US)

(72) Inventors: Sidharam BIRADAR, Portland, OR (US); Sachin Krishna KUDVA, Bangalore (IN); Jaiprakash SHRIVASTAV, Portland, OR (US)

(21) Appl. No.: 19/406,705

(22) Filed: Dec. 2, 2025

Related U.S. Application Data
(60) Provisional application No. 63/886,616, filed on Sep. 23, 2025.

(51) Int. Cl. H04L 9/40; H04L 9/08

(52) U.S. Cl. CPC H04L 63/0457; H04L 9/0891

(57) ABSTRACT

Examples described herein relate to a component interconnect bus comprising multiple lanes for serial data transfer between a root port and an endpoint and circuitry to refresh keys used to encrypt or decrypt data. In some examples, during utilization of a first key set to encrypt data transmitted between the root port and the endpoint using the component interconnect bus, the circuitry can add a second key set for encryption of second data for transmission between the root port and the endpoint.

### RELATED APPLICATION

This application claims the benefit of priority to U.S. Patent Application 63/886,616, filed Sep. 23, 2025. The entire contents of that application are incorporated by reference.

### DESCRIPTION

In confidential computing environments, data in transit is encrypted to reduce a likelihood of being read or altered by interposers and devices. Peripheral Component Interconnect Special Interest Group (PCI-SIG) introduced Integrity and Data Encryption (PCIe IDE) as an Engineering Change Notice (ECN) to the PCIe Generation 5 specifications. PCIe IDE aims to protect data integrity and confidentiality during high-speed data transfers between a host system and endpoint device through a Security Protocol and Data Model (SPDM) and IDE protocol. Link IDE streams protect PCIe Transaction Layer Packets (TLPs) between a root complex root port and endpoint port. Selective IDE streams allow for control over what data is encrypted and provides flexibility to accept TLPs from specific requester identifiers (RIDs) or address range. Selective IDE stream allows host software to control the acceptable address and RID range for data encryption and decryption.

### BRIEF DESCRIPTION OF THE DRAWINGS

FIG. 1 depicts an example system.

FIG. 2 depicts an example of operations.

FIG. 3 shows an example process.

FIG. 4 depicts a system.

### DETAILED DESCRIPTION

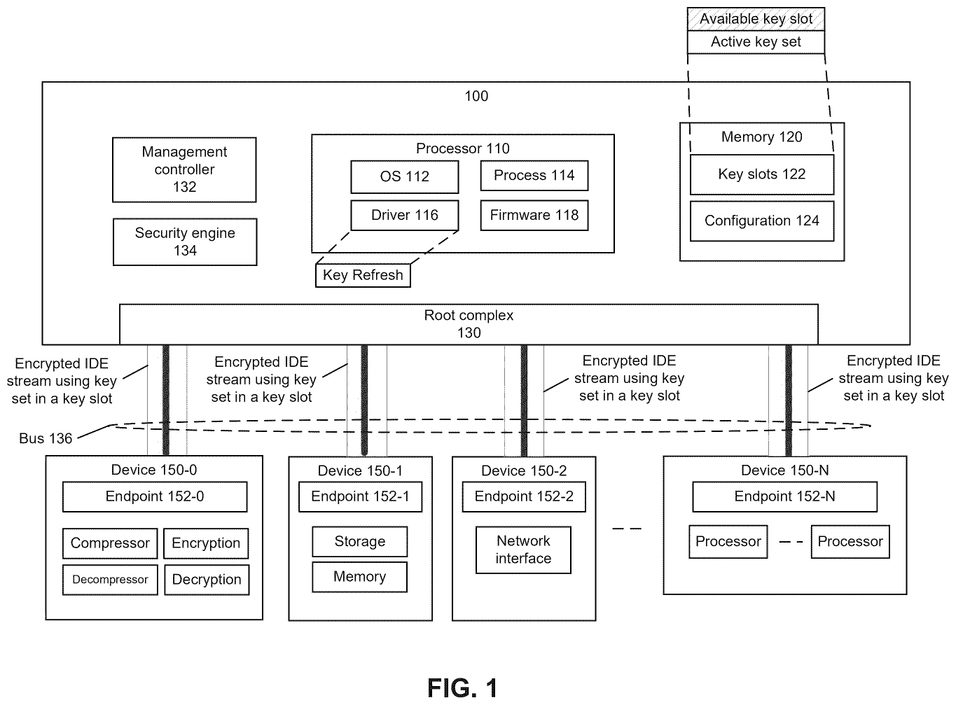

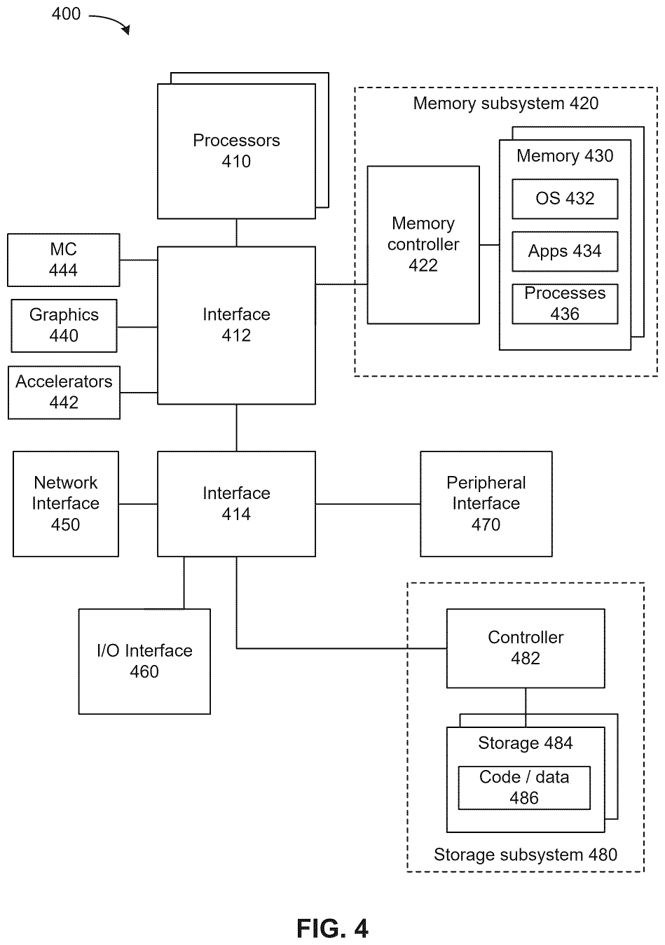

FIG. 1 depicts an example system. Host 100 can include one or more processors 110, memory 140, and other circuitry and software described at least with respect to FIG. 4. Processors 110 can execute at least one or more of: operating system (OS) 112, processes 114, driver 116, and other software. Driver 116 can provide a communication interface between OS 112 and root complex 130. Processes 114 can include one or more of: an application, process, thread, a virtual machine (VM), microVM, container, microservice, virtual function (VF), virtual device, or other virtualized execution environment. Processes 114 can access devices 150-0 to 150-N, where N is an integer, as PCIe endpoints 152-0 to 152-N using a component interconnect bus 136 via root complex 130. The PCIe protocol is described in Peripheral Component Interconnect (PCI) Express Base Specification 1.0 (2002), as well as earlier versions, later versions, and variations thereof. Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

In some examples, component interconnect bus 136 can provide one or more parallel lanes of data paths for serial and point-to-point communication between two devices (e.g., motherboard and expansion card); data transfer rate is based on a generation number of an applicable standard and number of lanes; backward compatibility with older generations of the applicable standard; hot-plug capability to add or remove a connected device without restarting a host system; slots are mechanically capable of more lanes than are active; or others.

Devices 150-0 to 150-N can include one or more of: an accelerator, graphics processing unit (GPU), storage device, network interface device, or other circuitry. For example, an accelerator can perform cryptographic, compression, or decompression operations on data stored in memory 120.

Memory 120 can include one or more registers, volatile memory, non-volatile memory, cache, or other circuitry. As described herein, memory 120 can store keys in key slots 122. In some examples, key slots 122 can be implemented as registers. For example, a selected Key Set configuration 124 in a control register can be changed to indicate which key set and key slots to use to encrypt or decrypt link IDE stream communications between root complex 130 and a particular PCIe endpoint among endpoints 152-0 to 152-N.

Management controller (MC) 132 can include a processor configured to perform monitoring of server health, including temperature, fan speeds, and power status. Management controller 132 can be configured to respond to remote actions by performance of actions such as power cycling, booting, and resetting the server. Management controller 132 can provide management capabilities independent of OS 112, through a dedicated management network port and can support protocols such as Intelligent Platform Management Interface (IPMI) and Redfish. Management controller 132 can provide telemetry and crash data for troubleshooting and proactive maintenance. Management controller 132 can be used to automate the initial setup and firmware updates for servers. An example management controller 132 can include Baseboard Management Controller (BMC) from Intel®, a specialized microcontroller on server motherboards that allows for remote monitoring and management of the hardware.

In some examples, OS 112, firmware 118, or other circuitry can periodically generate PCIe IDE keys and MC 132 can store new keys used to encrypt and decrypt link IDE streams. Various examples of firmware 118 can include one or more of: Basic Input/Output System (BIOS), Universal Extensible Firmware Interface (UEFI), or a boot loader. In some examples, firmware 118 can periodically generate PCIe IDE keys and MC 132 or SE 134 can store new keys used to encrypt and decrypt link IDE streams. Keys can be generated in accordance with Advanced Encryption Standard (AES) Galois/Counter Mode (GCM) 256-bit (AES-GCM-256), AES-GCM-SIV, ChaCha20-Poly1305, XChaCha20-Poly1305, or others.

Security engine (SE) 134 can include a privileged firmware (FW) module executed in a processor of a processor socket. SE 134 can perform tasks such as secure boot to ensure that only trusted code runs at startup, key management, and attestation to prove the system's trustworthiness to other devices or software. In some examples, a security engine can include a Secure Startup Services Module (S3M) from Intel®. In some examples, firmware 118 can periodically generate PCIe IDE encryption and decryption keys and SE 134 can store new keys to encrypt and decrypt link IDE streams.

Root complex 130 can provide a fabric and interface among processor 110, memory 120, devices 150-0 to 150-N, and/or other devices (e.g., management controller 132 or security engine 134). In some examples, root complex 130 and component interconnect bus 136 can provide communications among processors 110 and devices 150-0 to 150-N using one or more lanes in a manner that is consistent at least with PCI Express (PCIe), or other standards. Other standards can include at least: Advanced Micro Devices, Inc. (AMD) HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification version 1.0 (2019), as well as earlier versions, later versions, and variations thereof), or others. Root complex 130 can include one or more root ports, which can include physical or logical connections to a PCIe fabric. While the example shows a root complex for a host system, the root complex can be used in a switch or other device.

For encrypting or decrypting data, PCI-SIG defines an IDE Key Management (KM) flow that establishes a set of keys that are common to both root complex 130 and endpoints 152-0 to 152-N in respective devices 150-0 to 150-N. As described herein, keys are programmed into key slots 122 for a root port of root complex 140 and end points of devices 150-0 to 150-N. For an encrypted stream (e.g., Link or Selective type), two key sets are defined: one key set for encrypting data to be transmitted (Tx key set) to an endpoint or root port and one key set for decrypting received data (Rx key set) at an endpoint or root port. A key set can include a combination of three keys for the three data sub-streams, namely: Posted Transactions (P), Non-posted Transactions (NP), and Completions (C). For example, to establish a configuration of four IDE streams, eight different key sets are to be defined, for a total of 24 different keys.

A number of registers in memory 120 available to store key sets may be limited but keys are to be replaced so that if active keys are compromised, communications can take place using replacement keys. Various examples provide a key refresh system to add or replace keys used to encrypt and decrypt data during active traffic transmission and receipt while keys utilized for at least some IDE Streams were previously stored and can be utilized. For example, during utilization of a first key set to encrypt and/or decrypt data transmitted between a root port and an endpoint, a second key set can be stored to add keys used to encrypt and decrypt data between the same root port and same endpoint.

By providing capability to update encryption keys, risk of unauthorized data access can be reduced, providing a defense against evolving security threats. Additionally, the system's scalability and flexibility make it suitable for various network sizes and configurations, simplifying administration and reducing complexity.

Various examples of the IDE stream establishment flow can be performed by a processor executed device driver 116. In some examples, driver 116 can perform key refresh operations, described herein. Key refresh operations can be periodic or triggered by management controller 132 or security engine 134. Key refresh can track the mapping for active and primed key sets in key slots 122 to identify utilized and available key set registers in key slots 122. Key slots 122 can include IDE control and status registers. For example, available key set registers can be used for storing a new key set in key slots 122. Key refresh can store a key set for link or selective IDE streams for a Root Port. Key refresh can update encryption keys without interrupting ongoing data traffic. Key refresh can apply when an IDE stream switches to a new set of keys for its individual sub streams (e.g., Posted Sub-stream, Non-posted Sub-stream, Completion Sub-Stream, or others). Keys can be generated by firmware 118 in some examples.

In some examples, X number of Key Slot indices (e.g., X Tx keys and X Rx keys) can be utilized to store key sets. For example, streams can be programmed with keys associated with indices 1-3, 4-6, 7-9, 10-12, or 13-15 because an IDE stream utilizes 3 Tx and 3 Rx Keys for the 3sub-streams. For example, for a port, two key sets can be defined (e.g., Key Set 0 (KS0) and Key Set 1 (KS1)) with one of these key sets used at a time. Although other numbers of key sets can be defined and one key set is used at a time.

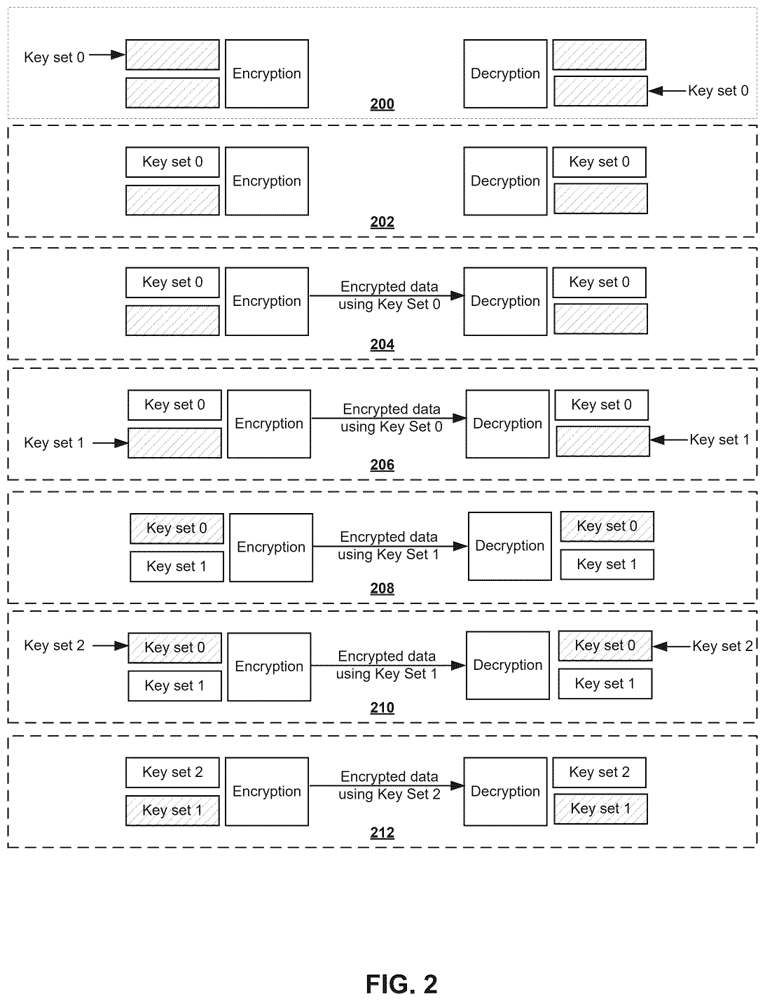

FIG. 2 depicts an example of operations to configure and change keys of a single stream. At 200 and 202, a link IDE Stream can be established between a host system (e.g., system 100) and device (e.g., one or more of devices 150-0 to 150-N) using a Key Set 0 (KS0) stored in key slot registers that are not utilized. The key set can include 6 keys (e.g., 3 receive (RX) and 3transmit (TX)). After link IDE stream establishment using KS0, at 204, a device driver can enable an identifier (ID) for a stream at the host and device to permit data transmission encrypted and decrypted using KS0. Note that the encryption can apply to traffic transmitted from the host to the device, with decryption occurring at the device, or traffic transmitted from the device to the host, with encryption occurring at the device and decryption occurring at the host.

At 206, while traffic (e.g., PCIe TLPs) encrypted and decrypted using KS0 are transmitted between host and device, a driver (e.g., driver 116) can perform a key refresh to add Key Set 1 (KS1) to an available key slot. The driver can command a security engine or management controller to store a generated KS1, determine registers that are available (e.g., do not store active keys) that can store KS1 by firmware or other source, and store the KS1 into the available registers.

At 208, the driver can enable the keys of KS1 (e.g., Rx_Prime_Key_Set_1, Tx_Prime_Key_Set_1) and utilize KS1 to encrypt and decrypt communications between host and device in upstream and downstream directions. Key Refresh from KS0 to KS1 is successfully completed. At 208, IDE Traffic is sent in upstream and downstream directions using KS1.

At 210, while traffic (e.g., PCIe TLPs) encrypted and decrypted using KS1 are transmitted between host and device, a driver (e.g., driver 116) can perform a key refresh to add Key Set 2 (KS2) to an available key slot. In this example, the available key slot corresponds to key slots for KS0, which are unused. The driver can command a security engine or management controller to store a KS2 generated by firmware or other source, determine registers that are available (e.g., do not store active keys) that can store KS2, and store the KS2 into the available registers.

At 212, the driver can enable the keys of KS2 (e.g., Rx_Prime_Key_Set_2, Tx_Prime_Key_Set_2) and utilize KS2 to encrypt and decrypt communications between host and device in upstream and downstream directions. Key Refresh from KS1 to KS2 is successfully completed. Thereafter, IDE Traffic can be sent in upstream and downstream directions using KS2.

Note that while examples depict use of two key slots, more than two key slots can be used. For example, for three key slots, actively utilized keys can be stored in a first key slot and replacement keys can be stored in a second or third key slot.

In some examples, if a key slot is not available, a transmission can be interrupted and a key set can be added into a key slot for a key set utilized for data encryption and decryption. Thereafter, transmission can commence using the added key set.

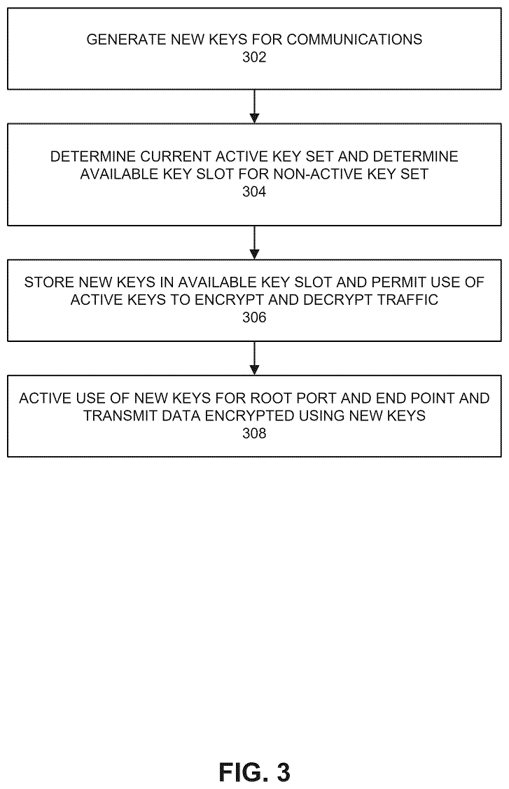

FIG. 3 depicts an example process to add a key set to an available key slot. The process to add or change a key can commence if IDE is enabled. IDE being enabled indicates a link is actively encrypting data and checking the integrity of selected PCIe traffic, using active key sets, and can block unprotected traffic from being received to provide confidentiality and integrity for data in transit, protecting against interception and tampering. At 302, new encryption and decryption keys can be generated for a root port and one or more endpoints. For example, the new keys can be generated by firmware. Host software (e.g., firmware, OS, or a trusted platform module) can act as an IDE Key Management (IDE_KM) Requester, establish a secure Security Protocol and Data Model (SPDM) session with the endpoint device, and generate the keys. A key set of encryption and decryption keys can be programmed into both the Root Port and Endpoint device via the defined register interface.

At 304, a current utilized key set and an available key slot can be determined. For example, available key slot indices can be determined that correspond to unused keys or that do not store keys. Indices can correspond to particular registers or positions within registers. In some examples, a key set includes keys for three data sub-streams, namely: Posted Transactions (P), Non-posted Transactions (NP), and Completions (C).

At 306, new keys can be stored in the available key slot while priming use of keys in another key slot to encrypt and decrypt traffic. Priming keys for use can indicate to make a newly programmed key set available for cryptographic operations. The internal Stream Control registers with the key slot indices can be set up in order to make the newly programmed key set available and ready for cryptographic operations (encryption/decryption) by the root port and endpoint. At 308, use of new keys can commence by the root port and end point. For example, a Selected Key Set configuration in a control register can be changed to indicate to use the updated key set. Use of the new key set can occur after determining a utilized key set in a Last Received Sub-Stream packet that utilizes a prior key set. A K bit in the TLP prefix for a substream can indicate a utilized key set.

FIG. 4 depicts a system. The system can use examples to add encryption and decryption keys for communication among various circuitries of system 400 (e.g., processor 410, graphics 440, one or more of accelerators 442, management controller (MC) 444, and/or network interface 450), as described herein. System 400 includes processor 410, which provides processing, operation management, and execution of instructions for system 400. Processor 410 can include any type of microprocessor, central processing unit (CPU), graphics processing unit (GPU), processing core, or other processing hardware to provide processing for system 400, or a combination of processors. Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 400 includes interface 412 coupled to processor 410, which can represent a higher speed interface or a high throughput interface for system components that needs higher bandwidth connections, such as memory subsystem 420 or graphics interface components 440, accelerators 442, or management controller 444. Interface 412 represents an interface circuit, which can be a standalone component or integrated onto a processor die.

Accelerators 442 can be a fixed function or programmable offload engine that can be accessed or used by a processor 410. For example, an accelerator among accelerators 442 can provide data compression (DC) capability, cryptography services such as public key encryption (PKE), cipher, hash/authentication capabilities, decryption, or other capabilities or services. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 442 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as static random-access memory (SRAM), dynamic random-access memory (DRAM), or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. In some examples, network interface 450 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory.

Some examples of network interface 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 450 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory is memory whose state (and therefore the data stored in it) is indeterminate if power is interrupted to the device. A non-volatile memory (NVM) device is a memory whose state is determinate even if power is interrupted to the device.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., Peripheral Component Interconnect express (PCIe), Compute Express Link (CXL), UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card. ” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more later examples and an apparatus comprising: a component interconnect bus comprising multiple lanes for serial data transfer between a root port and an endpoint and circuitry to: during utilization of a first key set to encrypt data transmitted between the root port and the endpoint using the component interconnect bus, add a second key set for encryption of second data for transmission between the root port and the endpoint.

Example 2 includes one or more earlier or later examples, wherein the add the second key set for encryption of data for transmission between the root port and the endpoint comprises identify an available register to store the second key set, store the second key set in the available register, and store an indication of a register that stores the second key set.

Example 3 includes one or more earlier or later examples, wherein: the component interconnect bus is to operate in a manner consistent with Peripheral Component Interface express (PCIe) and the circuitry is to configure the root port and endpoint to utilize the second key to encrypt and decrypt the second data.

Example 4 includes one or more earlier or later examples, wherein: the circuitry is to, during transmission of the encrypted second data to the endpoint, add a third key set for encryption of third data for transmission between the root port and the endpoint.

Example 5 includes one or more earlier or later examples, wherein the first key set is associated with a Peripheral Component Interface express (PCIe) link Integrity and Data Encryption (IDE) stream.

Example 6 includes one or more earlier or later examples, wherein the circuitry comprises a Peripheral Component Interface express (PCIe) root complex.

Example 7 includes one or more earlier or later examples, wherein the endpoint comprises a Peripheral Component Interface express (PCIe) endpoint and is to access one or more of: an accelerator, graphics processing unit (GPU), storage device, memory device, or network interface device.

Example 8 includes one or more earlier or later examples, wherein the first key set is associated with a Peripheral Component Interface express (PCIe) Posted Sub-stream, Non-posted Sub-stream, and Completion Sub-Stream.

Example 9 includes one or more earlier or later examples, and includes at least one non-transitory computer-readable medium comprising instructions stored thereon, that when executed by one or more processors, cause the one or more processors to: configure an interface between a root port and endpoint to: during utilization of a first key set to encrypt and decrypt data transmitted between the root port and the endpoint, store a second key set for encryption of second data for transmission between the root port and the endpoint and during utilization of the second key set to encrypt and decrypt data transmitted between the root port and the endpoint, store a third key set for encryption of second data for transmission between the root port and the endpoint.

Example 10 includes one or more earlier or later examples, wherein the store the second key set for encryption of data for transmission between the root port and the endpoint comprises identify an available register to store the second key set and store an indication of a register that stores the second key set.

Example 11 includes one or more earlier or later examples, wherein: the first key set is associated with a Peripheral Component Interface express (PCIe) link Integrity and Data Encryption (IDE) stream, the second key set is associated with the PCIe link IDE stream, and the third key set is associated with the PCIe link IDE stream.

Example 12 includes one or more earlier or later examples, wherein the root port is consistent with a Peripheral Component Interface express (PCIe) root port.

Example 13 includes one or more earlier or later examples, wherein the endpoint comprises a Peripheral Component Interface express (PCIe) endpoint and is to access one or more of: an accelerator, graphics processing unit (GPU), storage device, memory device, or network interface device.

Example 14 includes one or more earlier or later examples, wherein the first key set is associated with a Peripheral Component Interface express (PCIe) Posted Sub-stream, Non-posted Sub-stream, and Completion Sub-Stream.

Example 15 includes one or more earlier or later examples, a method that includes: while transmitting data, between a root port and an endpoint, encrypted and decrypted using a first key set, adding a second key set and ceasing use of the first key set; and transmitting second data between the root port and the endpoint, wherein the transmitting second data between the root port and the endpoint comprises: using the second key set to encrypt and decrypt second data transmitted between the root port and the endpoint and indicating the second key set is an active key set in a stream of the second data.

Example 16 includes one or more earlier or later examples, wherein: the adding the second key set comprises identifying an available register to store the second key set, storing the second key set in the available register, and storing an indication of a register that stores the second key set.

Example 17 includes one or more earlier or later examples, wherein: the first key set is associated with a Peripheral Component Interface express (PCIe) link Integrity and Data Encryption (IDE) stream and the second key set is associated with the PCIe link IDE stream.

Example 18 includes one or more earlier or later examples, wherein: the root port is consistent with a Peripheral Component Interface express (PCIe).

Example 19 includes one or more earlier or later examples, wherein: the endpoint comprises a Peripheral Component Interface express (PCIe) endpoint and is to access one or more of: an accelerator, graphics processing unit (GPU), storage device, memory device, or network interface device.

Example 20 includes one or more earlier examples, wherein: the first key set is associated with a Peripheral Component Interface express (PCIe) Posted Sub-stream, Non-posted Sub-stream, and Completion Sub-Stream.

1. An apparatus comprising:
a component interconnect bus comprising multiple lanes for serial data transfer between a root port and an endpoint and
circuitry to:
during utilization of a first key set to encrypt data transmitted between the root port and the endpoint using the component interconnect bus, add a second key set for encryption of second data for transmission between the root port and the endpoint.

2. The apparatus of claim 1, wherein the add the second key set for encryption of data for transmission between the root port and the endpoint comprises identify an available register to store the second key set, store the second key set in the available register, and store an indication of a register that stores the second key set.

3. The apparatus of claim 1, wherein:
the component interconnect bus is to operate in a manner consistent with Peripheral Component Interface express (PCIe) and
the circuitry is to configure the root port and endpoint to utilize the second key to encrypt and decrypt the second data.

4. The apparatus of claim 3, wherein:
the circuitry is to, during transmission of the encrypted second data to the endpoint, add a third key set for encryption of third data for transmission between the root port and the endpoint.

5. The apparatus of claim 1, wherein the first key set is associated with a Peripheral Component Interface express (PCIe) link Integrity and Data Encryption (IDE) stream.

6. The apparatus of claim 1, wherein the circuitry comprises a Peripheral Component Interface express (PCIe) root complex.

7. The apparatus of claim 1, wherein the endpoint comprises a Peripheral Component Interface express (PCIe) endpoint and is to access one or more of: an accelerator, graphics processing unit (GPU), storage device, memory device, or network interface device.

8. The apparatus of claim 1, wherein the first key set is associated with a Peripheral Component Interface express (PCIe) Posted Sub-stream, Non-posted Sub-stream, and Completion Sub-Stream.

9. At least one non-transitory computer-readable medium comprising instructions stored thereon, that when executed by one or more processors, cause the one or more processors to:
configure an interface between a root port and endpoint to:
during utilization of a first key set to encrypt and decrypt data transmitted between the root port and the endpoint, store a second key set for encryption of second data for transmission between the root port and the endpoint and
during utilization of the second key set to encrypt and decrypt data transmitted between the root port and the endpoint, store a third key set for encryption of second data for transmission between the root port and the endpoint.

10. The computer-readable medium of claim 9, wherein the store the second key set for encryption of data for transmission between the root port and the endpoint comprises identify an available register to store the second key set and store an indication of a register that stores the second key set.

11. The computer-readable medium of claim 9, wherein:
the first key set is associated with a Peripheral Component Interface express (PCIe) link Integrity and Data Encryption (IDE) stream,
the second key set is associated with the PCIe link IDE stream, and
the third key set is associated with the PCIe link IDE stream.

12. The computer-readable medium of claim 9, wherein the root port is consistent with a Peripheral Component Interface express (PCIe) root port.

13. The computer-readable medium of claim 9, wherein the endpoint comprises a Peripheral Component Interface express (PCIe) endpoint and is to access one or more of: an accelerator, graphics processing unit (GPU), storage device, memory device, or network interface device.

14. The computer-readable medium of claim 9, wherein the first key set is associated with a Peripheral Component Interface express (PCIe) Posted Sub-stream, Non-posted Sub-stream, and Completion Sub-Stream.

15. A method comprising:
while transmitting data, between a root port and an endpoint, encrypted and decrypted using a first key set, adding a second key set and
ceasing use of the first key set; and
transmitting second data between the root port and the endpoint, wherein the transmitting second data between the root port and the endpoint comprises:
using the second key set to encrypt and decrypt second data transmitted between the root port and the endpoint and
indicating the second key set is an active key set in a stream of the second data.

16. The method of claim 15, wherein:
the adding the second key set comprises identifying an available register to store the second key set, storing the second key set in the available register, and storing an indication of a register that stores the second key set.

17. The method of claim 15, wherein:
the first key set is associated with a Peripheral Component Interface express (PCIe) link Integrity and Data Encryption (IDE) stream and
the second key set is associated with the PCIe link IDE stream.

18. The method of claim 15, wherein:
the root port is consistent with a Peripheral Component Interface express (PCIe).

19. The method of claim 15, wherein:
the endpoint comprises a Peripheral Component Interface express (PCIe) endpoint and is to access one or more of: an accelerator, graphics processing unit (GPU), storage device, memory device, or network interface device.

20. The method of claim 15, wherein:
the first key set is associated with a Peripheral Component Interface express (PCIe) Posted Sub-stream, Non-posted Sub-stream, and Completion Sub-Stream.
